(19) United States
(12) Patent Application Publication
(10) Pub. No.: US 2007/0002365 A1
(43) Pub. Date: Jan. 4, 2007

(54) Tools for distributed printing of documents

(75) Inventors: Robert Joseph Pesar, Rochester, NY (US); Kevin Michael Nuwer, Ontario, NY (US); Hyo-Suk Helen Ko, Mendon, NY (US)

Correspondence Address: Anthony L. Miele;Miele Law Group, 137 South Main Street, Natick, MA, 01760, US

(73) Assignee: Xerox Corporation

(21) Appl. No.: 11/169,593

(22) Filed: Jun. 29, 2005

(51) Int. Cl. G06F 3/12

(52) U.S. Cl. 358/1.15; 358/1.1

(57) ABSTRACT

In one embodiment, an apparatus is provided. A printer selector allows a sender to select via a computer screen a printer to be used for printing a document. A print notification message generator generates a print notification message to a recipient list intended to receive the document. The print notification message includes a document identifier identifying the document and printer identifier identifying the printer. A message sender electronically sends the print notification message to each recipient on the recipient list. A document sender sends the document to the printer.

### BACKGROUND

One or more aspects of the disclosure may relate to systems and methods for notifying people to print a data file.

In today's business environment, meetings occur on a regular, if not daily, basis. These meetings involve a variety of individuals, such as clients, colleagues, and peers. Often times in preparation for these meetings, a meeting organizer prepares documents, such as slides, and forwards them to the attendees in advance of a meeting. Many systems exist for sending documents electronically to attendees of meetings. One such system is electronic mail. When a document is electronically sent to the attendees, attendees may arrive at meetings with the wrong version of the document (e.g., printed in black and white instead of color) or without the document at all.

The organizer may insert certain formatting into meeting documents to ensure that the documents appear a certain way. However, as each attendee may use a different printer with different settings, the documents may not print as the meeting organizer intended.

### BRIEF SUMMARY OF THE DISCLOSURE

In one embodiment, an apparatus is provided. A printer selector allows a sender to select via a computer screen a printer to be used for printing a document. A print notification message generator generates a print notification message to a recipient list intended to receive the document. The print notification message includes a document identifier identifying the document and printer identifier identifying the printer. A message sender electronically sends the print notification message to each recipient on the recipient list. A document sender sends the document to the printer.

### BRIEF DESCRIPTION OF THE DRAWINGS

FIG. 1 is a schematic block diagram of a print notification system.

FIG. 2 is a schematic representation of a part of an embodiment of a print notification system in a print driver.

FIG. 3 is a schematic representation of a print notification message.

FIG. 4 is a schematic block diagram of a sender interface on a sender computer system.

FIG. 5 is a schematic block diagram of a recipient interface on a recipient computer system.

FIG. 6 is a flowchart of a process by which a sender generates a print notification message using an example print notification system.

### DETAILED DESCRIPTION

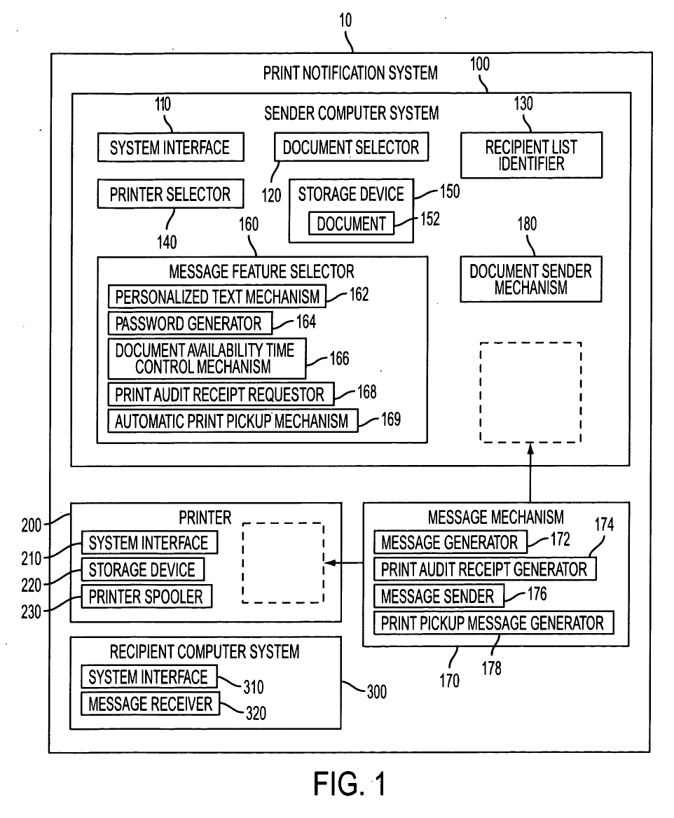

FIG. 1 is a block diagram of a print notification system 10. The illustrated system 10 includes a sender computer system 100, a printer 200, and a recipient computer system 300. A “computer system,” in embodiments, may include an individual computer (e.g., laptops, desktops, workstations, etc.) or a network of individual computers with the appropriate operating systems and application programs, or it may be any combination of computing mechanisms or portions thereof and program instructions or modules. A “printer,” in embodiments, may be a system or device, or combination thereof, with the capability of printing a paper copy of an electronic document.

Print notification system 10 may contain a plurality of sender computer systems 100, printers 200, and recipient computer systems 300, and the connections to any of these systems need not be permanent. However, for ease of explanation, it will be assumed in the following that the illustrated system 10 has one sender computer system 100, one printer 200 and one recipient system 300. The communication among sender computer system 100, printer 200 and recipient computer system 300 may be achieved through a direct connection, with cables or wireless, or through an indirect connection, such as the Internet or a local area network. In the embodiment shown, communication between each of the sender computer system 100, printer 200 and recipient system 300 is through system interface 110, 210, and 310, respectively.

In this embodiment, sender computer system 100 includes a system interface 110, a document selector 120, a recipient list identifier 130, a printer selector 140, a storage device 150, a message feature selector 160, a message mechanism 170 and a document sender mechanism 180. System interface 110 allows the sender computer system 100 to communicate with other entities, such as printer 200, recipient computer system 300 and sender. The sender is a person or entity seeking to send a print notification message to one or more recipients via their computer systems. A print notification message, in embodiments, is a message that provides recipients with information regarding a document (printed or to be printed). In the illustrated embodiment, the print notification message is in the form of an email. However, in other embodiments, other electronic communication methods are appropriate, e.g., instant messaging.

Document selector 120 allows a sender to select the document he or she wants a recipient of a print notification message to print out in paper form. The sender may have previously saved the document with the desired formatting. Recipient list identifier 130 allows the sender to identify who he or she wants to receive a print notification message. Printer selector 140 allows the sender to select the printer to be used by the recipients to print out the selected document. Storage device 150 contains at least one document 152 for the sender to choose using document selector 120.

Message feature selector 160 allows the sender to select certain message features associated with the print notification message and document 152. In the illustrated embodiment, message feature selector 160 includes a personalized text mechanism 162, a password generator 164, a document availability time control mechanism 166, a print audit receipt requestor 168, and an automatic print pickup mechanism 169. Personalized text mechanism 162 allows the sender to insert personalized text to be included in the system generated print notification message. Password generator 164 generates a password to limit access to document 152 to only the recipient list. Password generator 164 may generate a password unique to each recipient. Document availability time control mechanism 166 limits the amount of time document 152 is available to the recipient for printing on printer 200. Print audit receipt requestor 168 allows the sender to request to receive a receipt message when each recipient prints out document 152. Automatic print pickup mechanism 169 instructs printer 200 to automatically print document 152 for each recipient when the print notification message is sent to each recipient. In some embodiments, automatic print pickup mechanism 169 causes printer 200 to print a personalized cover sheet derived from the recipient list for each recipient.

Message mechanism 170 generates and sends print notification messages, as well as optional messages as determined by the selections of the sender using message feature selector 160. Message mechanism 170 includes a message generator 172, a print pickup audit receipt generator 174, a message sender 176, and a print pickup message generator 178. Message generator 172 generates the print notification message to be sent to each recipient on the recipient list in accordance with the message features selected by the sender using message feature selector 160. Print audit receipt generator 174 generates an electronic receipt to be sent to the sender when each recipient prints out document 152, if this message feature is selected by the sender. Print pickup message generator 178 generates a print pickup message to each recipient to pickup document 152 at the selected printer 200, if the sender selects the automatic print pickup message feature. Message sender 176 sends messages that are generated by message generator 172, print audit message generator 174, and print pickup message generator 178.

Message mechanism 170 may, e.g., be part of printer 200 or part of sender computer system 100. Document sender mechanism 180 assembles the recipient list with document 152, and forwards this combined document 152 to storage device 220 of printer 200 for the recipients to retrieve when they are ready.

Printer 200 includes a system interface 210, a storage device 220, and a printer spooler 230. In the illustrated embodiment, printer 200 is connected to sender computer system 100 and recipient computer system 300 via a local area network that allows a recipient to request document 152 to be printed remotely. In some embodiments, printer 200 includes a separate computer system attached to a printer. In other embodiments, printer 200 requires a recipient to physically interface with the printer controls on printer 200 to print out document 152.

System interface 210 allows the printer to interface with external entities including sender computer system 100 and receiver computer system 300. Printer spooler 230 queues the documents for printing.

Recipient computer system 300 includes a system interface 310 and a message receiver 320. System interface 310 allows recipient computer system 300 to interface with external entities including sender computer system 100, printer 200, and the recipient in the illustrated system. Message receiver 320 receives the print notification message from message mechanism 170 via system interface 110.

In the illustrated embodiment, document selector 120, recipient list identifier 130, printer selector 140, message feature selector 160, message mechanism 170, and document sender mechanism 180 are each implemented as a coded software program on a computer. Alternatively, they may be implemented as a general or specific special purpose computing mechanism or any other computing mechanism or portion thereof capable of performing the described functions. For example, any of these elements could be a general purpose microprocessor provided with an appropriate set of program instructions or program modules that cause a computer, ASIC or other computing element to perform the described functions. The same can be said of printer spooler 230 and message receiver 320.

Storage device 150 is a hard drive on sender computer system 100. However, in other embodiments, storage device 150 is any appropriate memory device capable of storing computer files, such as a separate server. Storage device 220 is a separate server reserved for printer 200 that shares access privileges with sender computer system 100 and recipient system 300. However, in other embodiments, storage device 220 is any appropriate memory device capable of storing computer files.

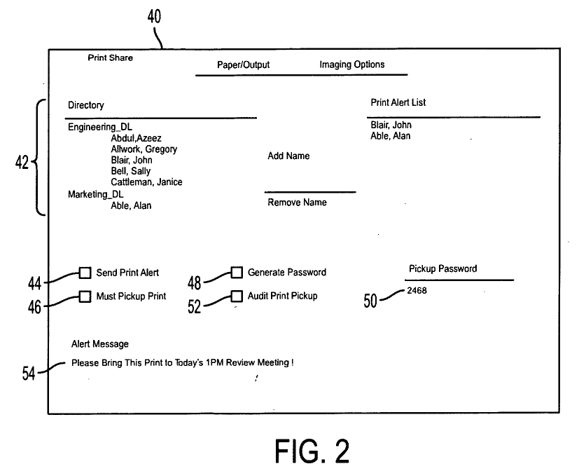

Parts of notification system 10 may be incorporated into the print driver of sender computer system 100 in some embodiments, as illustrated in FIG. 2. FIG. 2 shows three tabs for a sender to interact with the print driver. The “Print Share” tab 40 illustrates certain elements of sender computer system 100 described above in FIG. 1.

Directory/print alert list 42 operates as the recipient list identifier 130 allowing the sender to select the names to be included on the recipient list. Selecting the “Send Print Alert” option box 44 associates the selected recipient list with document 152 to perform a function of document sender mechanism 180. Selecting the “Must Pickup Print” option box 46 uses automatic print pickup mechanism 169 and print pickup message generator 178 to generate a print pickup message to each recipient and print document 152 using printer 200. Selecting the “Generate Password” option box uses password generator 164 to generate a password for each recipient. “Pickup Password” box also uses password generator 164 to allow the sender to personally select a password for recipients to enter to access document 152, in this example, “2468”. Selecting “Audit Print Pickup” option box 52 allows the sender to audit when each recipient prints document 152 using print audit receipt requestor 168 and print audit receipt generator 174. “Alert message” box 54 uses personalized text mechanism 162 to add a personalized note to the print notification message. In this example, “Please Bring This Print to Today's 1 PM Review Meeting!” will be added to the print notification message.

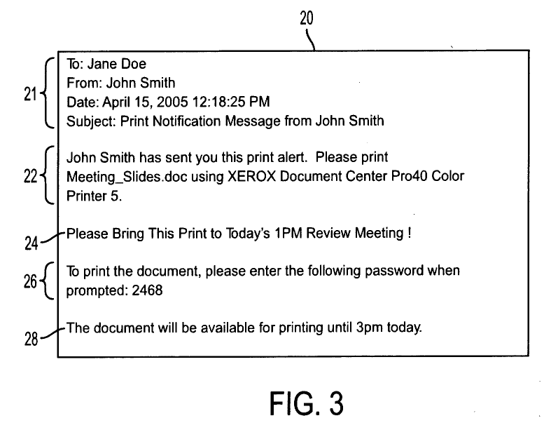

FIG. 3 is an illustrated example of a print notification message 20. In the illustrated embodiment, print notification message 20 is an email generated by message generator 172 in accordance with the features selected by the sender using the message feature selector 160 (described above with reference to FIG. 1). Header text 21 displays the name of the recipient, name of the sender; computer generated subject line, and the date and time print notification message 20 was sent. System generated general text 22 provides the basic text the system generates when the sender sends a basic message without selecting additional message features using message feature selector 160. This includes the name of the document, “meeting_slides.doc,” and the name of the selected printer, “XEROX Document Centre Pro 40 Color printer #5,” using document selector 120 and printer selector 140, respectively.

Personalized text 24 is an example of personalized text inserted by the sender using personalized text mechanism 162. Password text 26 is an example of text that would appear if the sender selected to use password generator 164 to password protect the document. Document availability time control text 28 is an example of the text that would be included in the message if the sender used document availability time control mechanism 166 to limit the availability of the document to be printed.

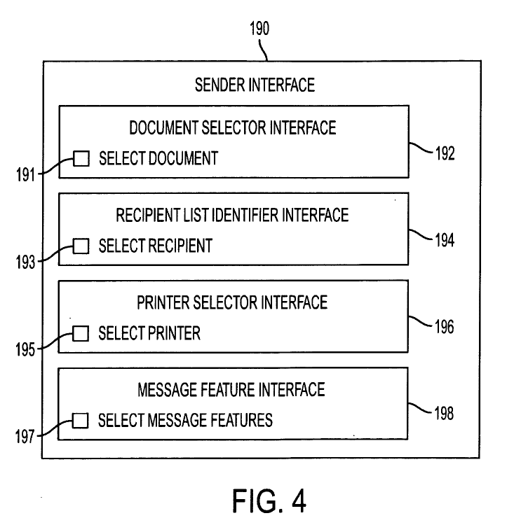

FIG. 4 is a schematic illustration of a sender interface as part of system interface 110 of sender computer system 100. Sender interface 190 includes a document selector interface 192, a recipient list identifier interface 194, a printer selector interface 196, and a message feature interface 198.

In embodiments, a graphical tool may, for example, include an icon or button that can be activated by clicking a mouse with a cursor situated over the icon or button. A graphical tool may include a form or textual input represented on a computer screen. A graphical tool may include a menu or displayed symbols or text that could be chosen by pointing to and clicking over a given symbol or text. The graphical tool can also include a drop down menu or any other type of graphical tool. Alternatively, other tools may be provided to allow a sender to control and operate sender interface 190.

Document selector interface 192 may include icons or otherwise manipulable graphical tools to allow the sender to select the document to be printed by the recipients at 191. A browse icon may be included to allow the sender to use a browse function to select the document to be printed.

Recipient list identifier interface 194 may include icons or otherwise manipulable graphical tools to allow the sender to identify the recipient list of the print notification message at 193. Recipient list identifier interface 194 may be used in combination with an email application. In some embodiments, recipient list identifier interface 194 may access or attach to an online or local directory of email addresses to allow the sender to easily click and select email addresses.

Printer selector interface 196 may include icons or otherwise manipulable graphical tools to allow the sender to select the printer to be used to print the selected document at 195. Again, a browse icon may be included to allow the sender to use a browse function to select the printer to be used.

The message feature interface 198 may include icons or otherwise manipulable graphical tools to allow the sender to select message and document features available through the message feature selector 160 at 197.

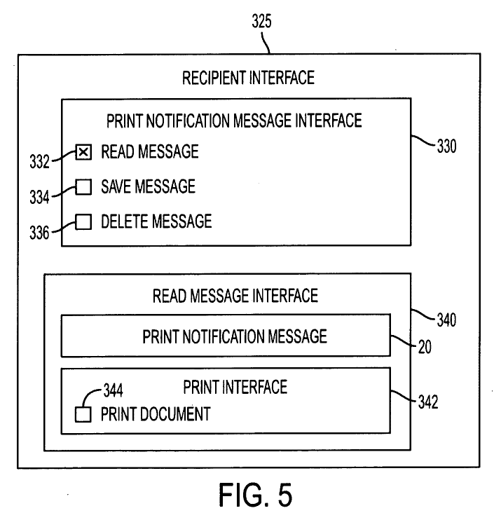

FIG. 5 is a schematic illustration of a recipient interface 325 as part of the system interface 310 of the recipient computer system 300. Recipient interface 325 includes a print notification message interface 330 and a read message interface 340. Print notification message interface 330 may include icons or otherwise manipulable graphical tools to allow the recipient to read print notification message 20 at 332, save print notification message 20 at 334, or delete print notification message 20 at 336. Print notification message interface 330 may work together with an email application or as a separate application.

If the recipient chooses to read print notification message 20, read interface 340 includes print notification message 20 and a print interface 342. If the recipient chooses to print the document from print interface 342, print interface 342 instructs printer 200 via system interface 210 to print the document using executable code, such as a script. Print interface 342 may include icons or otherwise manipulable graphical tools to allow the recipient to remotely print the document at 344.

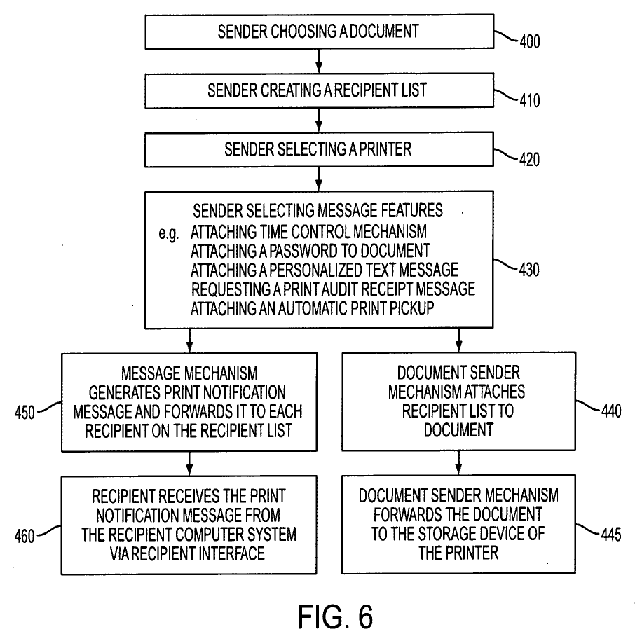

FIG. 6 is a flow chart of a process by which a sender distributes a print notification message using print notification system 10. In act 400, sender selects a document 152 using document selector interface 192 and document selector 120 (please refer to previously described FIGS. 1, 4, and 5 for references to system and interface elements) that he or she would like to send a print notification message to a list of recipients. In act 410, sender identifies a recipient list to receive a print notification message via recipient list identifier interface 194 and recipient list identifier 130. In act 420, the sender selects a printer 200 that the list of recipients shall use to print document 152 using printer selector interface 196 and printer selector 140.

In optional act 430, sender selects optional message features to be included in the print notification message using message feature interface 198 and message feature selector 160. These features may include entering personalized text to include in the message, generating a password to limit access to document 152, and limiting the time availability to access document 152 for printing, generating a print pickup message when document 152 is automatically printed, and requesting a print audit receipt when each recipient prints document 152.

In a next act 440, document sender mechanism 180 attaches the recipient list to document 152. In a next act 445, document sender mechanism 180 forwards document 152 to storage device 220 of printer 200 for each recipient to retrieve for printing. Simultaneous or following act 440, in act 450 message mechanism 170 generates a print notification message and forwards the print notification message to each recipient on the recipient list. In a final act 460, each recipient receives the print notification message via recipient interface 325.

This system may operated on its own or be combined with other computer application programs, such as appointment or meeting calendar applications, e.g., Microsoft Outlook.

Each element described hereinabove may be implemented with a hardware processor together with computer memory executing software or with specialized hardware for carrying out the same functionality. Any data handled in such processing or created as a result of such processing can be stored in any type of memory available to the artisan and appropriate for such data. For disclosure herein, a machine readable media comprises any form of data storage mechanism, including the above-noted different memory technologies, as well as hardware or circuit representations of such structures and of such data.

The claims as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a printer selector to allow the sender to select via a computer screen a printer to be used for printing a document;
a print notification message generator to generate a print notification message addressed to a recipient list intended to receive the document, the print notification message including a document identifier identifying the document to be printed and a printer identifier identifying the printer to be used;
a message sender to electronically send the print notification message to each recipient on the recipient list; and
a document sender to send the document to the printer.

2. The apparatus according to claim 1, wherein the apparatus further comprises a document selector to allow the sender to select via a computer screen the document to be printed at the printer, and a recipient list identifier to allow the sender to identify via a computer screen the recipient list to receive the print notification message.

3. The apparatus according to claim 1, wherein the apparatus further comprises a printer, and wherein the printer comprises the print notification message generator.

4. The apparatus according to claim 1, wherein the apparatus further comprises a sender computer system, and wherein the sender computer system comprises the print notification message generator.

5. The apparatus according to claim 1, wherein the document sender further comprises an attachment mechanism to attach the recipient list to the document.

6. The apparatus according to claim 1, wherein the document sender comprises an automatic print setting to cause the printer to print the document automatically upon receipt from the document sender.

7. The apparatus according to claim 1, wherein the message sender comprises a repeat send mechanism to resend the print notification message until the recipient causes the document to be printed by the printer.

8. The apparatus according to claim 1, wherein the apparatus further comprises:
a print audit receipt mechanism to generate and send to the sender a print audit receipt message indicating when the recipient prints the document with the printer.

9. A method comprising:
selecting a printer to print a document in response to sender input via a computer screen interface;
generating a print notification message addressed to a recipient list intended to receive the document, the print notification message including a document identifier identifying the document and a printer identifier identifying the printer to be used;
electronically sending the print notification message to each recipient on the recipient list; and
sending the document to the printer.

10. The method according to claim 9, further comprising:
choosing the document to be printed in response to sender input via a computer screen interface.

11. The method according to claim 9, further comprising:
creating a recipient list to retrieve the document in response to sender input via a computer screen interface.

12. The method according to claim 9, further comprising:
the printer printing the document automatically when the printer receives the document; and
providing each recipient with a print retrieve message instructing retrieval of a printed copy of the document at the printer.

13. The method according to claim 9, further comprising:
printing the document using the printer;
providing the sender with a print audit receipt message indicating which recipients have printed the document.

14. The method according to claim 9, further comprising:
providing in the print notification message personalized text from the sender.

15. The method according to claim 9, further comprising:
inserting a time control mechanism to control the period of time the document is available to print by each recipient.

16. The method according to claim 9, further comprising:
generating and attaching a password to the document limiting access to the document.

17. Machine-readable media encoded with data, the data being interoperable with a machine to cause:
selecting a printer to print a document in response to sender input via a computer screen interface;
generating a print notification message addressed to a recipient list intended to receive the document, the print notification message including a document identifier identifying the document and a printer identifier identifying the printer to be used;
electronically sending the print notification message to each recipient on the recipient list; and
sending the document to the printer.

18. The machine-readable media according to claim 17, the data being interoperable with a machine to cause:
choosing the document to be printed in response to sender input via a computer screen interface.

19. The machine-readable media according to claim 17, the data being interoperable with a machine to cause:
creating a recipient list to retrieve the document in response to sender input via a computer screen interface.

20. The machine-readable media according to claim 17, the data being interoperable with a machine to cause:
the printer printing the document automatically when the printer receives the document.
